(19) United States
(12) Patent Application Publication
(10) Pub. No.: US 2014/0323381 A1
(43) Pub. Date: Oct. 30, 2014

(54) ACYL HYDRAZONES AS BLEACH-BOOSTING ACTIVE SUBSTANCES

(71) Applicant: Henkel AG & Co. KGaA, Duesseldorf (DE)

(72) Inventors: Andre Hatzelt, Duesseldorf (DE); Michael Dreja, Neuss (DE)

(21) Appl. No.: 14/327,664

(22) Filed: Jul. 10, 2014

Related U.S. Application Data
(63) Continuation of application No. PCT/EP2013/050232, filed on Jan. 8, 2013.

(30) Foreign Application Priority Data
Jan. 11, 2012 (DE) 10 2012 200 333.9

(51) Int. Cl. C11D 3/32; C11D 3/39

(52) U.S. Cl. CPC C11D 3/32; C11D 3/3945
USPC 510/309; 510/375

(57) ABSTRACT

The aim of the invention is to improve the cleaning performance of washing and cleaning agents against stains from polysaccharide-containing food residue. This is substantially achieved by incorporating a combination of peroxide bleaching agents with specific acyl hydrazones.

### FIELD OF THE INVENTION

The present invention generally relates to the removal of stains of food residues from fabrics or hard surfaces by the combination of bleaching agents with certain acyl hydrazones.

### BACKGROUND OF THE INVENTION

Stains of food residues belong to the consumer-relevant difficulty removable stains; they often comprise food additives such as thickeners or stabilizers. Among these, hydrocolloids based on polysaccharides are frequently encountered, which hydrate in cold or hot water and form viscous solutions, dispersions or gels. Useful polysaccharides can be of natural origin or be manufactured by modification of them. The natural polysaccharides include algae extracts, vegetal extracts, hydrocolloids from seeds or roots, and hydrocolloids obtained by microbial fermentation. The modified or semi-synthetic hydrocolloids include for example cellulose and starch derivatives and similar compounds, such as methoxypectins, propylene glycol alginates and carboxymethyl and hydropropyl guar kernel meal.

Guarane, a polysaccharide that is frequently encountered in food residues, can be obtained from the seed walls of the Leguminose Cyamopsis tetragonoloba and has a 1-4-β-D-mannopyranosyl backbone. It is employed as a thickener, in particular in prepared sauces and frozen foods, but also in chocolate. The polysaccharide obtained from locust bean tree pods is likewise frequently used in the food industry; it also possesses a 1-4-β-D-mannopyranosyl backbone and differs from guarane supposedly by a lower number of D-galactosyl side chains. In Leguminosae seeds water-soluble galactomannane generally makes up the major fraction of stocked carbohydrates, which in some cases can contribute up to 20% of the dry weight. Galactomannane has α-galactosyl residues bound to O-6 of mannose and can also be at least partially acetylated on O-2 and O-3 of the mannose residues.

These hydrocolloids have a very high affinity to cellulose and are only removed with difficulty, even with modern bleaching agents. In the international patent applications WO 99/09130 and WO 99/09131 the proposal was made to use mannanase and percarbonate, and mannanase and a hydrophobic bleach activator, respectively, for this purpose.

Metal complexes with acyl hydrazone ligands that carry electron-withdrawing substituents in proximity to the acyl group are known from the international patent application WO 2009/124855.

A subject matter of the present invention is the use of a combination of a peroxidic bleaching agent with an acyl hydrazone for improving the soil removal power of washing or cleaning agents toward stains from polysaccharide-containing food residues, in particular toward stains that consist of chocolate or that have a chocolate content.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Use of a combination of a peroxidic bleaching agent with an acyl hydrazone of the general Formula I,

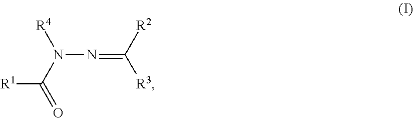

in which R¹ stands for a CF₃ or for a C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group; R² and R³ independently of one another stand for hydrogen or an optionally substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group or R2 and R3 together with the carbon atom linking them stand for an optionally substituted 5-, 6-, 7-, 8- or 9-membered ring that can optionally comprise heteroatoms; and R⁴ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₉ heteroalkyl, C₃₋₁₂ cycloheteroalkyl, C₅₋₁₆ heteroaralkyl group or an optionally substituted phenyl or naphthyl or heteroaryl group, for improving the soil removal power of washing or cleaning agents toward stains from polysaccharide-containing food residues.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A subject matter of the present invention is the use of a combination of a peroxidic bleaching agent with an acyl hydrazone of the general Formula I,

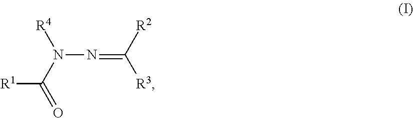

in which R¹ stands for a CF₃ or for a C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group, R² and R³ independently of one another stand for hydrogen or an optionally substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group or R2 and R3 together with the carbon atom linking them stand for an optionally substituted 5-, 6-, 7-, 8- or 9-membered ring that can optionally comprise heteroatoms, and
R⁴ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group,
for improving the soil removal power of washing or cleaning agents toward stains from polysaccharide-containing food residues, in particular toward stains that consist of chocolate or that have a chocolate content.

The acyl hydrazones can be in the E- or Z-configuration; if R² is hydrogen, the compound of the general Formula (I) can be in one of its tautomeric forms or exist as a mixture thereof.

In the compounds of the general Formula (I), R² is preferably hydrogen. R¹ and/or R³ is preferably a methyl, phenyl or naphthyl group substituted with an electron-withdrawing group. R⁴ is preferably hydrogen. The electron-withdrawing group is preferably an ammonium group that optionally carries alkyl or hydroxyalkyl groups or is formed by including the N-atom that carries an alkyl group as the optionally additional heterocycloalkyl group that carries heteroatoms.

Preferred developments of the compounds according to the general Formula (I) include those of the general Formula (II),

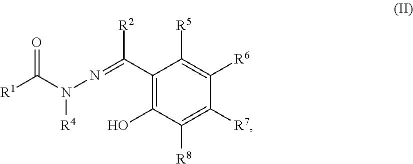

in which R¹ stands for a C₁₋₄ alkyl group that carries a substituent

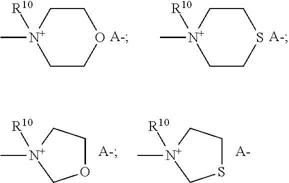

in which R¹⁰ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group and A⁻ stands for the anion of an organic or inorganic acid, R² and R⁴ have the meaning given for Formula (I) and
R⁵, R⁶, R⁷ and R⁸ independently of each other stand for R¹, hydrogen, halide, a hydroxy, amino, an optionally substituted N-mono- or di-C₁₋₄ alkyl or C₂₋₄ hydroxyalkylamino, N-phenyl or N-naphthylamino, C₁₋₂₈ alkyl, C₁₋₂₈ alkoxy, phenoxy, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl or naphthyl group, wherein the substituents are selected from C₁₋₄ alkyl-, C₁₋₄ alkoxy-, hydroxy, sulfo, sulfato, halo, cyano, nitro, carboxy, phenyl, phenoxy, naphthoxy, amino, N-mono- or di-C₁₋₄ alkyl or C₂₋₄ hydroxyalkylamino, N-phenyl or N-naphthylamino groups, or
R⁵ and R⁶ or R⁶ and R⁷ or R⁷ and R⁸ are linked together to form 1, 2 or 3 carbocyclic or O-, NR¹⁰- or S-heterocyclic, optionally aromatic and/or optionally C₁₋₆ alkyl-substituted rings.

The anion A⁻ is preferably carboxylate, such as lactate, citrate, tartrate or succinate, perchlorate, tetrafluoroborate, hexafluorophosphate, alkyl sulfonate, alkyl sulfate, hydrogen sulfate, sulfate, dihydrogen phosphate, hydrogen phosphate, phosphate, isocyanate, rhodanide, nitrate, fluoride, chloride, bromide, hydrogen carbonate or carbonate, wherein for multivalent anions the charge equalization can be achieved by the presence of additional cations, such as sodium or ammonium ions.

The compounds of the general Formula (I) boost the bleaching action of peroxidic bleaching agents, without unduly damaging the substrate to be cleaned, for example the fabric. The peroxidic bleaching agents are preferably H₂O₂ or substances that release H₂O₂ in water, including in particular alkali metal perborates, alkali metal percarbonates and urea perhydrates; however, they may be also possibly employed combined with peroxycarboxylic acids, such as diperoxydecanedicarboxylic acid or phthalimido peroxycaproic acid, with other acids or acidic salts, such as alkali metal persulfates or alkali metal peroxydisulfates or Caroates, or with diacyl peroxides or tetraacyl diperoxides.

The performance of compounds of the general Formula (I) can optionally be further boosted by the presence of manganese, titanium, cobalt, nickel or copper ions, preferably Mn(ll)-(lll)-(IV)-(V), Cu(l)-(ll)-(lll), Fe(l)-(II)-(III)-(IV), Co(l)-(ll)-(lll), Ni(l)-(ll)-(lll), Ti(ll)-(III)-(IV) and particularly preferably selected from Mn(ll)-(III)-(IV)-(V), Cu(l)-(ll)-(lll), Fe(l)-(II)-(III)-(IV) and Co(l)-(ll)-(lll); if desired, complex compounds of the cited metal central atoms with ligands of the general Formula (I) may also be employed.

In another preferred development of the invention, a compound is employed that forms a peroxycarboxylic acid under perhydrolysis conditions, in particular in the presence of peroxygen compounds that release H₂O₂, together with an acyl hydrazone of the general Formula I. Compounds that under perhydrolysis conditions afford optionally substituted perbenzoic acid and/or peroxycarboxylic acids containing 1 to 10 carbon atoms, in particular 2 to 4 carbon atoms, are preferred in this regard. Customary bleach activators, which carry O- and/or N-acyl groups are suitable, for example polyacylated alkylenediamines, in particular tetraacetylethylenediamine (TAED), acylated glycolurils, in particular tetraacetyl glycoluril, acylated triazine derivatives, in particular 1,5-diacetyl-2,4-dioxohexahydro-1,3,5-triazine (DADHT), acylated phenylsulfonates and -carboxylates, in particular nonanoyloxy- or isononanoyloxybenzenesulfonate or -benzoate, acylated polyhydric alcohols, in particular triacetin, ethylene glycol diacetate and 2,5-diacetoxy-2,5-dihydrofuran as well as acetylated sorbitol and mannitol, and acylated sugar derivatives, in particular pentaacetyl glucose (PAG), pentaacetyl fructose, tetraacetyl xylose and octaacetyl lactose as well as acetylated, optionally N-alkylated glucamine and gluconolactone. A compound that forms peroxycarboxylic acid under perhydrolysis conditions, and acyl hydrozone are preferably employed in molar ratios in the range of 4:1 to 100:1, in particular 25:1 to 50:1.

In the context of the use according to the invention, it is preferred if the concentration of the compound according to Formula (I) is 0.5 μmol/l to 500 μmol/l, in particular 5 μmol/l to 100 μmol/l in the aqueous washing or cleaning liquor, as can be employed for example in washing machines, but also for cleaning carpets or cushion materials or for cleaning hard surfaces, such as tiles, floor tiles or dishes that can also be carried out in automatic dishwashers. The concentration of manganese, titanium, cobalt, nickel or copper ions in the aqueous washing or cleaning liquor is preferably in the range of 0.1 μmol/l to 500 μmol/l, in particular 1 μmol/l to 100 μmol/l. Preferred peroxygen concentrations (calculated as H₂O₂) in the washing or cleaning liquor are in the range of 0.001 g/l to 10 g/l, in particular 0.1 g/l to 1 g/l and particularly preferably 0.2 g/l to 0.5 g/l. The inventive use is preferably carried out at temperatures in the range of 10° C. to 95° C., in particular 20° C. to 40° C. The water hardness of the water used for preparing the aqueous washing or cleaning liquor is preferably in the range of 0° dH to 16° dH, in particular 0° dH to 3° dH. The inventive use is preferably carried out at pH values in the range of pH 5 to pH 12, in particular pH 7 to pH 11.

The inventive uses can be particularly easily realized by employing a washing or cleaning agent that comprises the peroxidic bleaching agent and a compound of the Formula (I) or a bleach catalyst that is obtained by complexation of the latter with a cited transition metal ion.

A bleach-catalyzing complex that possesses a ligand with a structure according to Formula (I) can possess one or even a plurality of the corresponding ligands, in particular two. It can be mononuclear or optionally di or polynuclear. Moreover it can comprise additional neutral, anionic or cationic ligands, such as for example H₂O, NH₃, CH₃OH, acetyl acetone, terpyridine, organic anions, such as for example citrate, oxalate, tartrate, formate, a C₂₋₁₈ carboxylate, a C₁₋₁₈ alkyl sulfate, in particular methosulfate, or a corresponding alkane sulfonate, inorganic anions, such as for example halides, in particular chloride, perchlorate, tetrafluoroborate, hexafluorophosphate, nitrate, hydrogen sulfate, hydroxide or hydroperoxide. It can also possess bridging ligands, such as for example alkylenediamines.

The washing or cleaning agents preferably comprise 0.01 wt % to 2 wt %, particularly 0.05 wt % to 0.3 wt % of the compound according to Formula (I). When a compound of Formula (I) is comprised, the agent preferably additionally comprises a manganese, titanium, cobalt, nickel or copper salt and/or a manganese, titanium, cobalt, nickel or copper complex without a ligand that corresponds to a compound according to Formula (I). Then the molar ratio of the cited transition metal or the sum of the cited transition metals to the compound according to Formula (I) is preferably in the range of 0.001:1 to 2:1, particularly 0.01:1 to 1:1. In a further preferred development of the agent, the agent comprises 0.05 wt % to 1 wt %, particularly 0.1 wt % to 0.5 wt % of a bleach-catalyzing complex that possesses a ligand according to Formula (I). The preferred transition metal is manganese.

The peroxygen compounds that are optionally comprised in the agents particularly include organic peracids or peracid salts of organic acids, such as phthalimido peroxycaproic acid, peroxybenzoic acid or salts of diperoxydodecanedioic acid, hydrogen peroxide and inorganic salts that liberate hydrogen peroxide under the washing conditions, such as perborate, percarbonate and/or persilicate. In this regard, hydrogen peroxide can also be produced with the help of an enzymatic system, i.e. an oxidase and its substrates. If it is intended to use solid peroxygen compounds, then they can be used in the form of powders or pellets, which in principle can also be encapsulated by known methods. Alkali metal percarbonate, alkali metal perborate monohydrate, alkali metal perborate tetrahydrate or hydrogen peroxide in the form of aqueous solutions that comprise 3 wt % to 10 wt % hydrogen peroxide are particularly preferably employed. Peroxygen compounds are preferably present in washing or cleaning agents in amounts of up to 50 wt %, in particular 5 wt % to 30 wt %.

Washing and cleaning agents, which can be present in particular as powdery solids, in the form of post-compacted particles, as homogeneous solutions or suspensions, can comprise in principle all known and customary ingredients for such agents in addition to the inventively used combination of peroxidic bleaching agent and compound according to Formula (I). In particular, the agents can comprise builders, surface active surfactants, water-miscible organic solvents, enzymes, sequestrants, electrolytes, pH adjusters, polymers with special effects, such as soil release polymers, color transfer inhibitors, graying inhibitors, crease-reducing polymeric active substances and shape-retaining polymeric active substances, and further auxiliaries, such as optical brighteners, foam regulators, dyes and fragrances.

In addition to the previously cited ingredients, an agent can comprise customary antimicrobials for boosting the disinfection action, for example against specific germs. Such antimicrobial additives are preferably comprised in the disinfectants in amounts of up to 10 wt %, particularly from 0.1 wt % to 5 wt %.

Customary bleach activators that form peroxycarboxylic acids or peroxyimido acids under perhydrolysis conditions, and/or customary bleach-activating transition metal complexes can be additionally added to the substance to be used according to the invention. The optional components of the bleach activators, present in particular in amounts of 0.5 wt % to 6 wt %, include the customarily used N- or O-acyl compounds, for example polyacylated alkylenediamines, particularly tetraacetylethylenediamine, acylated glycolurils, in particular tetraacetyl glycoluril, N-acylated hydantoins, hydrazides, triazoles, urazoles, diketopiperazines, sulfuryl amides and cyanurates, also carboxylic acid anhydrides, particularly phthalic anhydride, carboxylic acid esters, particularly sodium isononanoyl phenol sulfonate, and acylated sugar derivatives, in particular pentaacetyl glucose, as well as cationic nitrile derivatives such as trimethylammonium acetonitrile salts. In order to avoid interaction with the peroxy compounds during storage, the bleach activators can be coated or granulated in a known manner with coating materials, wherein tetraacetylethylenediamine granulated with the help of carboxymethyl cellulose with mean particle sizes of 0.01 mm to 0.8 mm, granulated 1,5-diacetyl-2,4-dioxohexahydro-1,3,5-triazine, and/or trialkylammonium acetonitrile produced in particle form are particularly preferred. The washing or cleaning agents preferably comprise these types of bleach activators in amounts of up to 8 wt %, particularly 2 wt % to 6 wt %, each relative to the total agent.

The inventive agents can comprise one or more surfactants, wherein particularly anionic surfactants, non-ionic surfactants and their mixtures come into consideration, but also cationic and/or amphoteric surfactants can be comprised. Suitable non-ionic surfactants are particularly alkyl glycosides and ethoxylation and/or propoxylation products of alkyl glycosides or of linear or of branched alcohols, each with 12 to 18 carbon atoms in the alkyl moiety and 3 to 20, preferably 4 to 10 alkyl ether groups. Moreover, corresponding ethoxylation and/or propoxylation products of N-alkylamines, vicinal diols, fatty acid esters and fatty acid amides, which in regard to the alkyl moiety correspond to the cited long chain alcohol derivatives, as well as alkyl phenols with 5 to 12 carbon atoms in the alkyl group can be used.

Suitable anionic surfactants are particularly soaps and such that comprise sulfate or sulfonate groups, preferably with alkali metal ions as the cations. Useable soaps are preferably the alkali metal salts of the saturated or unsaturated fatty acids containing 12 to 18 carbon atoms. These types of fatty acids can also be used in a not completely neutralized form. The useable surfactants of the sulfate type include the salts of sulfuric acid half esters of fatty alcohols with 12 to 18 carbon atoms and the sulfation products of the mentioned non-ionic surfactants with a low degree of ethoxylation. The useable surfactants of the sulfonate type include linear alkylbenzene sulfonates with 9 to 14 carbon atoms in the alkyl moiety, alkyl sulfonates with 12 to 18 carbon atoms, as well as olefin sulfonates with 12 to 18 carbon atoms, which result from the reaction of the corresponding monoolefins with sulfur trioxide, as well as alpha-sulfofatty acid esters that result from the sulfonation of fatty acid methyl or ethyl esters.

These types of surfactants are preferably comprised in washing agents in amounts of 5 wt % to 50 wt %, particularly 8 wt % to 30 wt %, whereas disinfectants as well as cleaning agents for hard surfaces comprise preferably 0.1 wt % to 20 wt %, particularly 0.2 to 5 wt % surfactants.

The agents, in particular when they concern those intended for the treatment of fabrics, can comprise in particular one or more of the cationic, fabric softeners of the general Formulas X, XI or XII as the cationic active substances with fabric softening action:

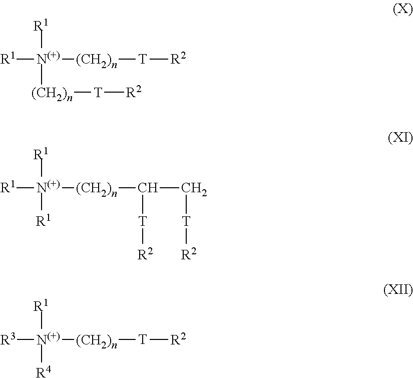

in which each group R¹, independently of one another, is selected from C₁₋₆ alkyl, -alkenyl or -hydroxyalkyl groups; each group R², independently of one another, is selected from C₈₋₂₈ alkyl or -alkenyl groups; R³=R¹ or (CH₂)ₙ-T-R²; R⁴=R¹ or R² or (CH₂)ₙ-T-R²; T=—CH₂—, —O—CO— or —CO—O— and n is an integer from 0 to 5. The cationic surfactants possess the usual number and type of anions required to compensate the charge, wherein these can be selected, besides for example halides, also from the anionic surfactants. In preferred embodiments, hydroxyalkyltrialkylammonium compounds, particularly C₁₂₋₁₈ alkyl(hydroxyethyl)dimethylammonium compounds, and preferably their halides, in particular chlorides, are used as the cationic surfactants. The agent preferably comprises 0.5 wt % to 25 wt %, particularly 1 wt % to 15 wt % of cationic surfactant.

A washing or cleaning agent preferably comprises at least one water-soluble and/or water-insoluble organic and/or inorganic builder. The water-soluble organic builders include polycarboxylic acids, particularly citric acid and sugar acids, monomeric and polymeric amino polycarboxylic acids, particularly methylglycine diacetic acid, nitrilotriacetic acid and ethylenediaminetetraacetic acid as well as polyaspartic acid, polyphosphonic acids, particularly amino tris(methylenephosphonic acid), ethylenediaminetetrakis(methylenephosphonic acid) and 1-hydroxyethane-1,1-diphosphonic acid, polymeric hydroxy compounds such as dextrin as well as polymeric (poly)carboxylic acids, particularly those polycarboxylates obtained from the oxidation of polysaccharides or dextrins, and/or polymeric acrylic acids, methacrylic acids, maleic acids and mixed polymers thereof, which can also comprise small amounts of copolymerized polymerizable substances exempt from carboxylic acid functionality. The relative molecular weight of the homopolymers of unsaturated carboxylic acids lies generally between 5000 and 200 000, that of the copolymers between 2000 and 200 000, preferably 50 000 to 120 000, each relative to free acid. A particularly preferred acrylic acid-maleic acid copolymer has a relative molecular weight of 50 000 to 100 000. Suitable, yet less preferred compounds of this class, are copolymers of acrylic acid or methacrylic acid with vinyl ethers, such as vinyl methyl ether, vinyl esters, ethylene, propylene and styrene, in which the content of the acid is at least 50 wt %. Terpolymers, which comprise two unsaturated acids and/or their salts as monomers as well as vinyl alcohol and/or an esterified vinyl alcohol or a carbohydrate as the third monomer, can also be used as the water-soluble organic builders. The first acidic monomer or its salt is derived from a monoethylenically unsaturated C₃-C₈ carboxylic acid and preferably from a C₃-C₄ monocarboxylic acid, particularly from (meth)acrylic acid. The second acidic monomer or its salt can be a derivative of a C₄-C₈ dicarboxylic acid, maleic acid being particularly preferred, and/or a derivative of an allyl sulfonic acid, which is substituted in the 2-position with an alkyl or aryl residue. These types of polymer generally have a relative molecular weight between 1000 and 200 000. Other preferred copolymers are those, which preferably contain acrolein and acrylic acid/acrylic acid salts or vinyl acetate as monomers. The organic builders, especially for the manufacture of liquid agents, can be employed in the form of aqueous solutions, preferably in the faun of 30 to 40 weight percent aqueous solutions. In general, all the cited acids are added in the form of their water-soluble salts, particularly their alkali metal salts.

These types of organic builders can be comprised as desired in amounts of up to 40 wt %, particularly up to 25 wt % and preferably from 1 wt % to 8 wt %. Amounts close to the cited upper limit are preferably incorporated in pasty or liquid, particularly aqueous agents.

The water-soluble inorganic builders particularly concern polymeric alkali metal phosphates that can be present in the form of their alkaline, neutral or acidic sodium or potassium salts. Examples of these are tetrasodium diphosphate, disodium dihydrogen diphosphate, pentasodium triphosphate, so-called sodium hexametaphosphate as well as the corresponding potassium salts or mixtures of sodium and potassium salts. In particular, crystalline or amorphous alkali metal alumosilicates in amounts of up to 50 wt %, preferably not more than 40 wt % and in liquid agents not more than 1 wt % to 5 wt % are added as the water-insoluble, water-dispersible inorganic builders. Among these, the detergent-quality crystalline sodium alumosilicates, particularly zeolites A, P and optionally X, are preferred. Amounts close to the cited upper limit are preferably incorporated in solid, particulate agents. Suitable alumosilicates particularly exhibit no particles with a particle size above 30 μm and preferably consist to at least 80 wt % of particles smaller than 10 μm. Their calcium binding capacity, which can be determined according to the indications of German patent DE 24 12 837, generally lies in the range of 100 to 200 mg CaO per gram.

Suitable substitutes or partial substitutes for the cited alumosilicate are crystalline alkali metal silicates that can be present alone or in a mixture with amorphous silicates. The alkali metal silicates that can be used as builders preferably have a molar ratio of alkali metal oxide to SiO₂ below 0.95, particularly 1:1.1 to 1:12 and can be amorphous or crystalline. Preferred alkali metal silicates are the sodium silicates, particularly the amorphous sodium silicates, with a molar ratio Na₂O:SiO₂ of 1:2 to 1:2.8. Crystalline silicates that can be present alone or in a mixture with amorphous silicates are preferably crystalline, layered silicates corresponding to the general Formula Na₂SiₓO₂ₓ₊₁ y H₂O, wherein x, the so-called module, is a number from 1.9 to 4 and y is a number from 0 to 20, preferred values for x being 2, 3 or 4. Preferred crystalline layered silicates are those in which x assumes the values 2 or 3 in the cited general formula. In particular, both β- as well as δ-sodium disilicates (Na₂Si₂O₅ y H₂O) are preferred. Practically anhydrous crystalline alkali metal silicates of the abovementioned general Formula, in which x is a number from 1.9 to 2.1 can be employed and can also be manufactured from amorphous alkali metal silicates. In a further preferred embodiment, a crystalline sodium layered silicate with a module of 2 to 3 is employed, as can be manufactured from sand and soda. In a further preferred embodiment, crystalline sodium silicates with a module in the range 1.9 to 3.5 are employed. In a preferred development, a granular compound of alkali metal silicate and alkali metal carbonate is added, as is commercially available, for example under the name Nabion® 15. In the case that alkali metal alumosilicate, in particular zeolite, is also present as the additional builder, then the weight ratio alumosilicate to silicate, each relative to anhydrous active substances, is preferably 1:10 to 10:1. In agents that comprise both amorphous and crystalline alkali metal silicates, the weight ratio of amorphous alkali metal silicate to crystalline alkali metal silicate is preferably 1:2 to 2:1 and particularly 1:1 to 2:1.

Builders are preferably comprised in washing or cleaning agents in amounts of up to 60 wt %, particularly from 5 wt % to 40 wt %.

In a preferred development, the agent possesses a water-soluble builder block. The use of the term “builder block” is intended to emphasize that the agents do not comprise other builders than water-soluble builders, i.e. all of the builders comprised in the agent are summarized in the stated “block”, wherein at the most, allowance is made for the amounts of materials that can be comprised in the customary ingredients of commercial agents as impurities or minor amounts of added stabilizers. The term “water-soluble” is intended to mean that the builder block, in the amount comprised in the agent, under normal conditions, dissolves without residue. The agents preferably comprise at least 15 wt % and up to 55 wt %, particularly 25 wt % to 50 wt %, of the water-soluble builder block. This is preferably composed of the components
a) 5 wt % to 35 wt % of citric acid, alkali metal citrate and/or alkali metal carbonate that can also be replaced at least in part by alkali metal hydrogen carbonate.
b) up to 10 wt % alkali metal silicate with a module in the range of 1.8 to 2.5,
c) up to 2 wt % phosphonic acid and/or alkali metal phosphonate,
d) up to 50 wt % alkali metal phosphate, and
e) up to 10 wt % polymeric polycarboxylate,
   wherein the indicated quantities are based on the total washing or cleaning agent. This is also true for all of the following indicated quantities, when not otherwise stated.

In a preferred embodiment, the water-soluble builder block comprises at least 2 of the components b), c), d) and e) in amounts of greater than 0 wt %.

With regard to the component a), in a preferred embodiment, there are comprised 15 wt % to 25 wt % alkali metal carbonate that can be replaced at least in part by alkali metal hydrogen carbonate, and up to 5 wt %, particularly 0.5 wt % to 2.5 wt % citric acid and/or alkali metal citrate. In an alternative embodiment, the component a) comprises 5 wt % to 25 wt %, particularly 5 wt % to 15 wt % citric acid and/or alkali metal citrate and up to 5 wt %, particularly 1 wt % to 5 wt % alkali metal carbonate that can be replaced at least in part by alkali metal hydrogen carbonate. If both alkali metal carbonate and also alkali metal hydrogen carbonate are present, then the component a) preferably includes alkali metal carbonate and alkali metal hydrogen carbonate in the weight ratio of 10:1 to 1:1.

With regard to the component b), in a preferred embodiment there are comprised 1 wt % to 5 wt % alkali metal silicate with a modulus in the range 1.8 to 2.5.

With regard to the component c), in a preferred embodiment there are comprised 0.05 wt % to 1 wt % phosphonic acid and/or alkali metal phosphonate. Phosphonic acids are also understood to include optionally substituted alkyl phosphonic acids that may also possess a plurality of phosphonic acid groups (so-called polyphosphonic acids). They are preferably selected from the hydroxy and/or aminoalkyl phosphonic acids and/or their alkali metal salts, such as, for example, dimethylaminomethane diphosphonic acid, 3-aminopropane-1-hydroxy-1,1-diphosphonic acid, 1-amino-1-phenyl-methane diphosphonic acid, 1-hydroxyethane-1,1-diphosphonic acid, amino-tris(methylene phosphonic acid), N,N,N′,N′-ethylenediamine-tetrakis(methylene phosphonic acid) and acylated derivatives of the phosphorous acids, which can also be employed in any mixtures.

With regard to the component d), in a preferred embodiment there are comprised 15 wt % to 35 wt % alkali metal phosphate, in particular trisodium polyphosphate. “Alkali metal phosphate” is here the collective term for the alkali metal (more particularly sodium and potassium) salts of the various phosphoric acids, in which metaphosphoric acids (HPO₃)ₙ and orthophosphoric acid (H₃PO₄) can be differentiated among representatives of higher molecular weight. The phosphates combine a plurality of inherent advantages: They act as alkalinity sources, prevent lime deposits on machine parts and lime incrustations in fabrics and, in addition, contribute towards the cleaning power. Sodium dihydrogen phosphate NaH₂PO₄ exists as the dihydrate (density 1.91 gcm⁻³, melting point 60° C.) and as the monohydrate (density 2.04 gcm⁻³). Both salts are white, readily water-soluble powders that on heating, lose the water of crystallization and at 200° C. are converted into the weakly acidic diphosphate (disodium hydrogen diphosphate, Na₂H₂P₂O₇) and, at higher temperatures into sodium trimetaphosphate (Na₃P₃O₉) and Maddrell's salt. NaH₂PO₄ shows an acidic reaction. It is formed by adjusting phosphoric acid with sodium hydroxide to a pH value of 4.5 and spraying the resulting “mash”. Potassium dihydrogen phosphate (primary or monobasic potassium phosphate, potassium diphosphate, KDP), KH₂PO₄, is a white salt with a density of 2.33 gcm⁻³, has a melting point of 253° C. (decomposition with formation of potassium polyphosphate (KPO₃)ₓ) and is readily soluble in water. Disodium hydrogen phosphate (secondary sodium phosphate), Na₂HPO₄, is a colorless, very readily water-soluble crystalline salt. It exists in anhydrous form and with 2 mol (density 2.066 gcm⁻³, water loss at 95° C.), 7 mol (density 1.68 gcm⁻³, melting point 48° C. with loss of 5 H₂O) and 12 mol of water (density 1.52 gcm⁻³, melting point 35° with loss of 5 H₂O), becomes anhydrous at 100° C. and, on fairly intensive heating, is converted into the diphosphate Na₄P₂O₇. Disodium hydrogen phosphate is prepared by neutralization of phosphoric acid with soda solution using phenolphthalein as the indicator. Dipotassium hydrogen phosphate (secondary or dibasic potassium phosphate), K₂HPO₄, is an amorphous white salt, which is readily soluble in water. Trisodium phosphate, tertiary sodium phosphate, Na₃PO₄, are colorless crystals with a density of 1.62 gcm⁻³ and a melting point of 73-76° C. (decomposition) as the dodecahydrate, as the decahydrate (corresponding to 19-20% P₂O₅) a melting point of 100° C., and in anhydrous form (corresponding to 39-40% P₂O₅) a density of 2.536 gcm⁻³. Trisodium phosphate is readily soluble in water with an alkaline reaction and is manufactured by evaporating a solution of exactly 1 mole disodium phosphate and 1 mole NaOH. Tripotassium phosphate (tertiary or tribasic potassium phosphate), K₃PO₄, is a white deliquescent granular powder with a density of 2.56 gcm⁻³, has a melting point of 1340° C. and is readily soluble in water through an alkaline reaction. It is produced by e.g. heating Thomas slag with carbon and potassium sulfate. Despite their higher price, the more readily soluble and therefore highly effective potassium phosphates are often preferred to corresponding sodium compounds in the detergent industry. Tetrasodium diphosphate (sodium pyrophosphate), Na₄P₂O₇, exists in anhydrous form (density 2.534 gcm⁻³, melting point 988° C., a figure of 880° C. has also been mentioned) and as the decahydrate (density 1.815-1.836 gcm⁻³, melting point 94° C. with loss of water). Both substances are colorless crystals that dissolve in water with an alkaline reaction. Na₄P₂O₇ is formed when disodium phosphate is heated to more than 200° C. or by reacting phosphoric acid with soda in a stoichiometric ratio and dehydrated by spray drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³, which is soluble in water, the pH of a 1% solution at 25° C. being 10.4. Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. In particular, the latter are known by various different names: fused or calcined phosphates, Graham's salt, Kurrol's salt and Maddrell's salt. All higher sodium and potassium phosphates are known collectively as condensed phosphates. The industrially important pentasodium triphosphate, Na₅P₃O₁₀ (sodium tripolyphosphate), is anhydrous or crystallizes with 6 H₂O to a non-hygroscopic white water-soluble salt, which has the general formula NaO—[P(O)(ONa)—O]ₙ—Na where n=3. Around 17 g of the salt free from water of crystallization dissolve in 100 g of water at room temperature, around 20 g at 60° C. and around 32 g at 100° C. After heating the solution for 2 hours at 100° C., around 8% orthophosphate and 15% diphosphate are formed by hydrolysis. In the preparation of pentasodium triphosphate, phosphoric acid is reacted with soda solution or sodium hydroxide in a stoichiometric ratio and the solution is dehydrated by spray-drying. Similarly to Graham's salt and sodium diphosphate, pentasodium triphosphate solubilizes many insoluble metal compounds (including lime soaps, etc.). K₅P₃O₁₀ (potassium tripolyphosphate), is marketed for example in the form of a 50 wt % conc. solution (>23% P₂O₅, 25% K₂O). The potassium polyphosphates are widely used in the washing and cleaning industry. Sodium potassium tripolyphosphates also exist and are also usable in the scope of the present invention. They are formed for example when sodium trimetaphosphate is hydrolyzed with KOH:

(NaPO₃)₃+2 KOH→Na₃K₂P₃O₁₀+H₂O

They may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may be used.

With regard to the component e), in a preferred embodiment of the agent, there are comprised 1.5 wt % to 5 wt % of polymeric polycarboxylate, particularly selected from the polymerization or copolymerization products of acrylic acid, methacrylic acid and/or maleic acid. Among these are the homopolymers of acrylic acid and more specifically those with an average molecular weight in the range of 5000 Da to 15 000 Da (PA standard) are particularly preferred.

Apart from the abovementioned oxidases, enzymes that can be used in the agents are those from the class of proteases, lipases, cutinases, amylases, pullulanases, mannanases, cellulases, hemicellulases, xylanases and peroxidases as well as their mixtures, for example proteases like BLAP®, Optimase®, Opticlean®, Maxacal®, Maxapem®, Alcalase®, Esperase®, Savinase®, Durazym® and/or Purafect® OxP, amylases like Termamyl®, Amylase-LT®, Maxamyl®, Duramyl® and/or Purafect® OxAm, lipases like Lipolase®, Lipomax®, Lumafast® and/or Lipozym®, cellulases like Celluzyme® and/or Carezyme®. Enzymatic active materials obtained from bacterial sources or fungi such as Bacillus subtilis, Bacillus licheniformis, Streptomyceus griseus, Humicola lanuginosa, Humicola insolens, Pseudomonas Pseudoalcaligenes or Pseudomonas cepacia are particularly suitable. The enzymes can be adsorbed on carriers and/or embedded in encapsulants in order to protect them against premature inactivation. They are comprised in washing, cleaning agents or disinfectants preferably in amounts of up to 10 wt %, particularly 0.2 wt % to 2 wt %, wherein enzymes that are stabilized against oxidative decomposition are particularly preferably employed.

In a preferred embodiment, the agent comprises 5 wt % to 50 wt %, particularly 8 to 30 wt % anionic and/or non-ionic surfactant, up to 60 wt %, particularly 5-40 wt % builder and 0.2 wt % to 2 wt % enzyme, selected from the proteases, lipases, cutinases, amylases, pullulanases, mannanases, cellulases, oxidases and peroxidases as well as their mixtures.

Organic solvents that can be employed in the washing and cleaning agents, particularly when the agents are in liquid or paste form, include alcohols with 1 to 4 carbon atoms, particularly methanol, ethanol, isopropanol and tert-butanol, diols with 2 to 4 carbon atoms, particularly ethylene glycol and propylene glycol, as well as their mixtures and the ethers derived from the cited classes of compounds. These types of water-miscible solvents are preferably present in the agents in amounts of not more than 30 wt %, particularly 6 wt % to 20 wt %.

To adjust a pH to a desired level that does not itself result from mixing the usual components, the agents can comprise acids that are compatible with the system and the environment, particularly citric acid, acetic acid, tartaric acid, malic acid, lactic acid, glycolic acid, succinic acid, glutaric acid and/or adipic acid, but also mineral acids, particularly sulfuric acid, or bases, particularly ammonium hydroxide or alkali metal hydroxides. These types of pH adjustors are preferably comprised in the agents in amounts of not more than 20 wt %, particularly 1.2 wt % to 17 wt %.

“Soil release” polymers, often called soil release substances, which provide the treated surface, for example fibers, with soil repellency are known as “soil repellents” and are non-ionic or cationic cellulose derivatives, for example. The particularly active polyester soil release polymers include copolyesters of dicarboxylic acids, for example adipic acid, phthalic acid or terephthalic acid, diols, for example ethylene glycol or propylene glycol, and polydiols, for example polyethylene glycol or polypropylene glycol. The preferred soil release polyesters employed include such compounds that are formally obtained by the esterification of two monomeric moieties, wherein the first monomer is a dicarboxylic acid HOOC-Ph-COOH and the second monomer is a diol HO—(CHR¹¹—)ₐ)_{b}OH that can also be present as the polymeric diol H—(O—(CHR¹¹—)ₐ)_{b}OH. Here, Ph means an o-, m- or p-phenylene group that can carry 1 to 4 substituents, selected from alkyl residues with 1 to 22 carbon atoms, sulfonic acid groups, carboxyl groups and their mixtures, R¹¹ is hydrogen, an alkyl residue with 1 to 22 carbon atoms and their mixtures, a is a number from 2 to 6 and b is a number from 1 to 300. Preferably, both monomer diol units —O—(CHR¹¹—)ₐO— and also polymeric diol units —(O—(CHR¹¹—)ₐ)_{b}O— are present in the resulting polyesters. The molar ratio of monomeric diol units to polymeric diol units is preferably in the range 100:1 to 1:100, particularly 10:1 to 1:10. The degree of polymerization b in the polymeric diol units is preferably in the range 4 to 200, particularly 12 to 140. The molecular weight or the average molecular weight or the maximum of the molecular weight distribution of preferred soil-releasing polyesters is in the range 250 to 100 000, particularly 500 to 50 000. The acid, based on the Ph group, is preferably selected from terephthalic acid, isophthalic acid, phthalic acid, trimellitic acid, mellitic acid, the isomers of sulfo phthalic acid, sulfo isophthalic acid and sulfo terephthalic acid and their mixtures. As long as their acid groups are not part of the ester linkages in the polymer, then they are preferably present in salt form, particularly as the alkali metal or ammonium salt. Among these, sodium and potassium salts are particularly preferred. If desired, instead of the monomer HOOC-Ph-COOH, small amounts, particularly not more than 10 mol % of other acids that possess at least two carboxyl groups, based on the fraction of Ph with the abovementioned meaning, can be comprised in the soil release polyester. Exemplary alkylene and alkenylene dicarboxylic acids include malonic acid, succinic acid, fumaric acid, maleic acid, glutaric acid, adipic acid, pimelic acid, suberic acid, azelaic acid and sebacic acid. The preferred diols HO—(CHR¹¹—)ₐOH include those in which R¹¹ is hydrogen and a is a number from 2 to 6, and those, in which a has the value 2 and R¹¹ is selected from hydrogen and alkyl residues with 1 to 10, particularly 1 to 3 carbon atoms. The last named diols are particularly preferably those of the formula HO—CH₂—CHR¹¹—OH, in which R¹¹ has the abovementioned meaning. Exemplary diol components are ethylene glycol, 1,2-propylene glycol, 1,3-propylene glycol, 1,4-butane diol, 1,5-pentane diol, 1,6-hexane diol, 1,8-octane diol, 1,2-decane diol, 1,2-dodecane diol and neopentyl glycol. Polyethylene glycol with an average molecular weight of 1000 to 6000 is particularly preferred among the polymeric diols. If desired, these polyesters can be end blocked, wherein the blocking groups can be alkyl groups with 1 to 22 carbon atoms and esters of monocarboxylic acids. The end groups bonded through ester linkages can be based on alkyl, alkenyl and aryl monocarboxylic acids containing 5 to 32 carbon atoms, particularly 5 to 18 carbon atoms. They include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, elaiostearic acid, arachic acid, gadoleic acid, arachidonic acid, behenic acid, erucic acid, brassidic acid, clupanodonic acid, lignoceric acid, cerotic acid, melissic acid, benzoic acid that can carry 1 to 5 substituents with a total of up to 25 carbon atoms, particularly 1 to 12 carbon atoms, for example tert-butylbenzoic acid. The end groups can also be based on hydroxymonocarboxylic acids containing 5 to 22 carbon atoms, examples of which include hydroxyvaleric acid, hydroxycaproic acid, ricinoleic acid, its hydrogenation product hydroxystearic acid, and o-, m- and p-hydroxybenzoic acid. The hydroxymonocarboxylic acids can themselves be linked with one another through their hydroxyl group and their carboxyl group and thus be present several fold in an end group. Preferably, the number of hydroxymonocarboxylic acid units per end group, i.e. their degree of oligomerization, is in the range 1 to 50, particularly 1 to 10. In a preferred development of the invention, polymers of ethylene terephthalate and polyethylene oxide terephthalate are used, in which the polyethylene glycol units have a molecular weight 750 to 5000 and the molar ratio of ethylene terephthalate to polyethylene oxide terephthalate is 50:50 to 90:10, alone or in combination with cellulose derivatives.

Color transfer inhibitors that can be used in agents for washing textiles particularly include polyvinyl pyrrolidones, polyvinyl imidazoles, polymeric N-oxides such as polyvinyl pyridine-N-oxide and copolymers of vinyl pyrrolidone with vinyl imidazole and optionally further monomers.

As fabric surfaces, particularly of rayon, spun rayon, cotton and their mixtures, can crease of their own accord because the individual fibers are sensitive to flection, bending, pressing and squeezing at right angles to the fiber direction, the agents can comprise anti-crease agents. They include for example synthetic products based on fatty acids, fatty acid esters, fatty acid amides, fatty acid alkylol esters, fatty acid alkylol amides or fatty alcohols that have mainly been treated with ethylene oxide, or products based on lecithin or modified phosphoric acid esters.

Graying inhibitors have the task of ensuring that the dirt removed from the hard surface and particularly from the textile fibers is held suspended in the wash liquor. Water-soluble colloids of mostly organic nature are suitable for this, for example glue, gelatins, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, aldehyde starches, for example, can be used instead of the abovementioned starch derivatives. Preference, however, is given to the use of cellulose ethers such as carboxymethyl cellulose (Na salt), methyl cellulose, hydroxyalkyl cellulose, and mixed ethers, such as methyl hydroxyethyl cellulose, methyl hydroxypropyl cellulose, methyl carboxymethyl cellulose and mixtures thereof, which can be employed, for example in amounts of 0.1 to 5 wt %, based on the agent.

The agents may comprise optical brighteners, in particular derivatives of diaminostilbene disulfonic acid or alkali metal salts thereof. Suitable optical brighteners are, for example, salts of 4,4′-bis-(2-anilino-4-morpholino-1,3,5-triazinyl-6-)stilbene-2,2′-disulfonic acid or compounds of similar structure which contain a diethanolamino group, a methylamino group, an anilino group or a 2-methoxyethylamino group instead of the morpholino group. Optical brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the abovementioned optical brighteners may also be used.

Particularly when used in automatic washing or cleaning processes, it can be advantageous to add conventional foam inhibitors to the agents. Suitable foam inhibitors include for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanized silica and also paraffins, waxes, microcrystalline waxes and mixtures thereof with silanized silica or bis-fatty acid alkylenediamides. Mixtures of various foam inhibitors, for example mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis stearylethylene diamide are preferred.

Furthermore, active substances to prevent tarnishing of silver objects, so-called silver corrosion inhibitors, can be incorporated in the agents. Preferred silver corrosion inhibitors are organic disulfides, dihydric phenols, trihydric phenols, optionally alkyl or aminoalkyl substituted triazoles such as benzotriazole and salts and/or complexes of cobalt, manganese, titanium, zirconium, hafnium, vanadium, or cerium, in which the cited metals are present in one of the valence states II, III, IV, V or VI.

The compound according to Formula (I) or the corresponding pre-prepared complex can be present in the form of powders or as granulates that can also be optionally coated and/or colored and can comprise conventional carrier materials and/or granulation auxiliaries. In the case that they are used in granular form, they can also comprise, if desired, additional active substances, particularly bleach activators.

The manufacture of solid agents is not difficult and in principle can be made by known methods, for example by spray drying or granulation, wherein peroxygen compounds and bleach activator combinations are optionally added later. For manufacturing the agent with an increased bulk density, particularly in the range of 650 g/l to 950 g/l, a preferred process is one with an extrusion step. Washing, cleaning agents or disinfectants in the form of aqueous solutions or other solutions comprising standard solvents are particularly advantageously manufactured by a simple mixing of the ingredients, which can be added as such or as a solution into an automatic mixer. In a preferred embodiment of agents in particular for the automatic washing of tableware, they are in the form of tablets.

### EXAMPLES

The primary washing power was measured at the temperatures listed in the following Table using cotton substrates that had been stained with standardized soils. The substrates were washed under the same conditions with a washing agent (V1) containing 12.5 wt % sodium percarbonate and 3.5 wt % TAED or with an otherwise identically formulated agent (M1), to which 0.2 wt % 4-(2-(2-((2-hydroxyphenylmethyl)methylene)-hydrazinyl)-2-oxoethyl)-4-methylchloride had been added. The treated material substrate was then dried and the color was measured. In the following Table the brightness value of the cotton sample is presented as the average of 6 separate measurements.

TABLE 1
Bleaching Power [remission value in %]

| Stain; Temperature | V1 | M1 |
|---|---|---|
| Chocolate milk/carbon black; 30° C. | 59.3 | 62.7 |
| Cocoa; 60° C. | 71.2 | 72.1 |
| Porridge; 60° C. | 76.9 | 78.3 |
| Drinking chocolate; 40° C. | 61.3 | 62.4 |
| Chocolate cream; 30° C. | 77.6 | 78.4 |
| “Mole”; 30° C. | 72.1 | 74.2 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A washing or cleaning agent comprising a peroxidic bleaching agent and an acyl hydrazone of the general Formula I, 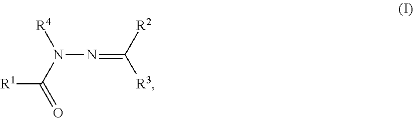
in which R¹ stands for a CF₃ or for a C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group,
R² and R³ independently of one another stand for hydrogen or an optionally substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group or R2 and R3 together with the carbon atom linking them stand for an optionally substituted 5-, 6-, 7-, 8- or 9-membered ring that can optionally comprise heteroatoms, and
R⁴ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group.

2. The washing or cleaning agent according to claim 1 further comprising a source of manganese, titanium, cobalt, nickel or copper ions.

3. A method for washing or leaning fabrics or hard surfaces, wherein a washing or cleaning agent according to claim 1 is employed in an aqueous washing or cleaning liquor and wherein the acyl hydrazone of the general Formula I, under perhydrolysis conditions, forms a peroxycarboxylic acid.

4. The method according to claim 3, wherein the concentration of the compound according to Formula I in the aqueous washing or cleaning liquor is 0.5 μmol/l to 500 μmol/l.

5. The method according to claim 3, wherein the washing or cleaning agent further comprises a source of manganese, titanium, cobalt, nickel or copper ions and wherein the concentration of manganese, titanium, cobalt, nickel or copper ions in the aqueous washing or cleaning liquor is 0.1 μmol/l to 500 μmol/l.

6. The method according to claim 3, wherein the peroxygen concentration (calculated as H₂O₂) in the aqueous washing or cleaning liquor is in the range of 0.001 g/l to 10 g/l.

7. The method according to claim 3, wherein it is carried out at temperatures in the range of 10° C. to 95° C.

8. The method according to claim 3, wherein the acyl hydrazine in the washing or cleaning agent corresponds to general Formula II, 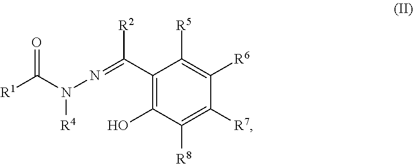
in which R¹ stands for a C₁₋₄ alkyl group that carries a substituent 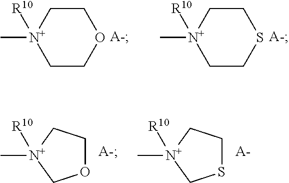
in which R¹⁰ stands for hydrogen or a C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group and A⁻ stands for an anion of an organic or inorganic acid,
R² and R⁴ have the meaning given for Formula (I) and
R⁵, R⁶, R⁷ and R⁸ independently of each other stand for R¹, hydrogen, halide, a hydroxy, amino, an optionally substituted N-mono- or di-C₁₋₄ alkyl or C₂₋₄ hydroxyalkylamino, N-phenyl or N-naphthylamino, C₁₋₂₈ alkyl, C₁₋₂₈ alkoxy, phenoxy, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl or naphthyl group, wherein the substituents are selected from C₁₋₄ alkyl-, C₁₋₄ alkoxy-, hydroxy, sulfo, sulfato, halo, cyano, nitro, carboxy, phenyl, phenoxy, naphthoxy, amino, N-mono- or di-C₁₋₄ alkyl or C₂₋₄ hydroxyalkylamino, N-phenyl or N-naphthylamino groups, or
R⁵ and R⁶ or R⁶ and R⁷ or R⁷ and R⁸ are linked together to form 1, 2 or 3 carbocyclic or O-, NR¹⁰- or S-heterocyclic, optionally aromatic and/or optionally C₁₋₆ alkyl-substituted rings.
